(19) United States
(12) Patent Application Publication
(10) Pub. No.: US 2007/0052656 A1
(43) Pub. Date: Mar. 8, 2007

(54) Flat panel display and manufacturing method thereof

(75) Inventors: Haeng-Won Park, Gyeonggi-do (KR); Seung-Hwan Moon, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/498,434

(22) Filed: Aug. 3, 2006

(30) Foreign Application Priority Data
Aug. 3, 2005 (KR) 2005-71141

(51) Int. Cl. G09G 3/36

(52) U.S. Cl. 345/100

(57) ABSTRACT

A flat panel display with reduced malfunction rate and improved image quality and a method for making such flat panel display are presented. The flat panel display is operated by a gate drive circuit that receives a first gate signal for driving a first gate line at one end of a data line and a second gate signal for driving a second gate line at the other end of the data line. First and second clock signals are supplied to the gate drive circuit, and the width of the first and second clock signal lines are adjusted such that a phase difference between the first gate signal and the second gate signal corresponds to a signal delay time between the two ends of the data line. The first and second clock signal lines and the gate and data lines are integrated.

### CROSS-REFERENCE TO RELATED APPLICATIONS

This U.S. non-provisional patent application claims priority, under 35 U.S.C. § 119, of Korean Patent Application 2005-71141 filed on Aug. 3, 2005, the entire content of which is hereby incorporated by reference.

### BACKGROUND OF THE INVENTION

1. Field of the Invention

The present invention relates to a flat panel display and a manufacturing method thereof.

2. Description of the Related Art

A display panel mounted on an electronic device forms an indispensable part of a typical user interface unit. For the user interface unit to be lightweight with a slim profile, and to achieve a low power consumption, flat panel displays are widely used as the display panel. Flat panel displays are classified into organic light emitting diodes (OLEDs), liquid crystal displays (LCDs), field emission displays (FEDs), vacuum fluorescent displays (VFDs), and plasma display panels (PDPs). Today, flat panel displays are used as computer displays or TV displays, as well as small, lightweight portable electronic devices that benefit from space efficiency and power saving.

FIG. 1 is a block diagram of an LCD, which is a widely used type of flat panel display.

Referring to FIG. 1, the LCD includes a liquid crystal panel 100, a source driver 110, and a gate driver 120.

The liquid crystal panel 100 includes a plurality of gate lines, a plurality of data lines intersecting the gate lines, and a plurality of pixels arranged at intersections of the gate lines and the data lines. The gate lines and the data lines intersect at a substantially perpendicular angle, and thus the pixels are arranged to form a matrix. Each of the pixels includes a thin film transistor (TFT) (not shown), a liquid crystal capacitor (not shown), and a storage capacitor (not shown). The TFT has a gate electrode connected to the gate line, a source electrode connected to the data line, and a drain electrode connected to the liquid crystal capacitor and the storage capacitor. In such a pixel structure, the gate lines are sequentially selected by the gate driver 120. When a gate-on voltage is applied to the selected gate lines in a pulse shape, the TFTs connected to the gate lines are turned on. Then, a voltage containing pixel information is applied to each of the data lines by the source driver 110. This voltage is applied to the liquid crystal capacitor and the storage capacitor through the TFT of the corresponding pixel. The liquid crystal capacitors and the storage capacitors are driven and an image display operation is achieved.

The source driver 110 includes a plurality of source driver ICs (integrated circuits) 111 to 114. In response to RGB data and control signals received from a timing controller (not shown), the source driver 110 generates signals for driving source lines of the liquid crystal panel 100.

The gate driver 120 includes a plurality of gate driver ICs 121 to 123. In response to control signals received from the timing controller, the gate driver 120 sequentially scans the gate lines of the liquid crystal panel 100. In this scanning operation, gate-on voltages are sequentially applied to the gate lines, and a pixel corresponding to the gate line to which the gate-on voltage is applied is changed into a data recordable state.

With the trend toward the high-definition and large flat panel display, the amount of time allowed for displaying one frame becomes reduced, and the amount of time allowed for charging a pixel becomes insufficient due to an increase in the parasitic capacitance of a data line. This problem causes various display failures, such as the non-uniformity of a screen image, failure in a vertical line, and cross talk.

In particular, as the length of the data line and the number of pixels connected to the data line are increased due to an increase in the size of the liquid crystal panel 100, greater delay is experienced by a data signal transmitted through the data line.

For example, a 12.1-inch (30.734 cm) WXGA (wide extended graphics array) LCD has the signal delay time of 3.62 μs when the data line has a resistance of 37.77 KΩ and a capacitance of 83 pF.

FIG. 2A illustrates waveforms of a data signal D1 and a gate signal G1 at a first position x1 of the liquid crystal panel illustrated in FIG. 1, and FIG. 2B illustrates waveforms of a data signal D1 and a gate signal Gn at a second position x2 of the liquid crystal panel illustrated in FIG. 1.

Referring to FIGS. 2A and 2B, if the pulse widths of the gate signals G1 and Gn are reduced by 3.62 μs, which is the delay time of the data signal D1, various display failures increase because of reduction in the pixel charging time.

Recently, a gate drive IC (integrated chip) is installed in an LCD in a TCP (tape carrier package) structure or a COG (chip on glass) structure. However, this structure has limitations in the design architecture and is associated with a high manufacturing cost of the LCD.

To overcome these limitations, there is proposed a gate IC-less structure in which an amorphous-silicon (a-Si) TFT circuit replaces the gate drive IC.

However, the LCD with the gate IC-less structure still has an operational problem due to delay of the data signal transmitted through the data line.

### SUMMARY OF THE INVENTION

Exemplary embodiments of the present invention provide a flat panel display capable of preventing malfunction that may be caused by a delay in a data signal transmitted through a data line.

Exemplary embodiments of the present invention also provide a flat panel display capable of performing a stable operation.

In one aspect, the present invention provides a method for manufacturing a flat panel display that can perform a stable operation.

In some embodiments, the flat panel displays include a plurality of gate lines. At least one data line intersects the gate lines, is electrically isolated from the gate lines, and has a predetermined signal delay time between one end and the other end of the data line. A pixel array is formed at intersections of the gate lines and the data line to be connected to the gate lines and the data line. A first clock line is used to transmit a first clock signal. A gate drive circuit drives the gate lines in response to the first clock signal received through the first clock line. A width of the first clock line is determined according to the predetermined signal delay time of the data line.

The flat panel displays may further include a second clock line for transmitting a second clock signal, and the gate drive circuit may drive the gate lines in response to the first clock signal and the second clock signal. A width of the second clock line may be determined according to the predetermined signal delay time of the data line. The second clock signal may be an inverted signal with respect to the first clock signal.

The gate drive circuit may include a first group of shift registers outputting a first group of gate signals for driving a first group of the gate lines in response to the first clock signal, and a second group of shift registers outputting a second group of gate signals for driving a second group of the gate lines in response to the second clock signal.

A phase difference between a gate signal for driving a first gate line at one end of the data line and another gate signal for driving a second gate line at the other end of the data line corresponds to the predetermined signal delay time.

In another aspect, the present invention is a method for manufacturing a flat panel display. The method includes forming a plurality of gate lines, forming at least one data line, and forming a first clock line having a first width that is determined according to the measured signal delay time of the data line.

In yet another aspect, the present invention is a method for manufacturing a flat panel display by measuring a signal delay time between one end and the other end of a data line intersecting a plurality of gate lines, the data line being electrically isolated from the gate lines. A width of a first clock line for transmitting a first clock signal to a gate drive circuit for driving the gate lines is adjusted such that a phase difference between a first gate signal for driving a first gate line at one end of the data line and a second gate signal for driving a second gate line at the other end of the data line corresponds to the measured signal delay time of the data line. The gate lines, the data line, and the first clock line are integrated.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an LCD that is one of flat panel displays;

FIG. 2A is a waveform diagram of a data signal and a gate signal at a first position of the liquid crystal panel illustrated in FIG. 1;

FIG. 2B is a waveform diagram of a data signal and a gate signal at a second position of the liquid crystal panel illustrated in FIG. 1;

FIG. 3 is a block diagram of an LCD according to an embodiment of the present invention;

FIG. 4 is a detailed block diagram of a gate drive circuit illustrated in FIG. 3;

FIG. 5 is a diagram illustrating a partial line structure of the gate drive circuit illustrated in FIG. 4;

FIG. 6 is a waveform diagram illustrating a delay time of a clock signal transmitted through a first clock line; and

FIG. 7 is a waveform diagram illustrating a delay time of a data signal and a delay between gate signals.

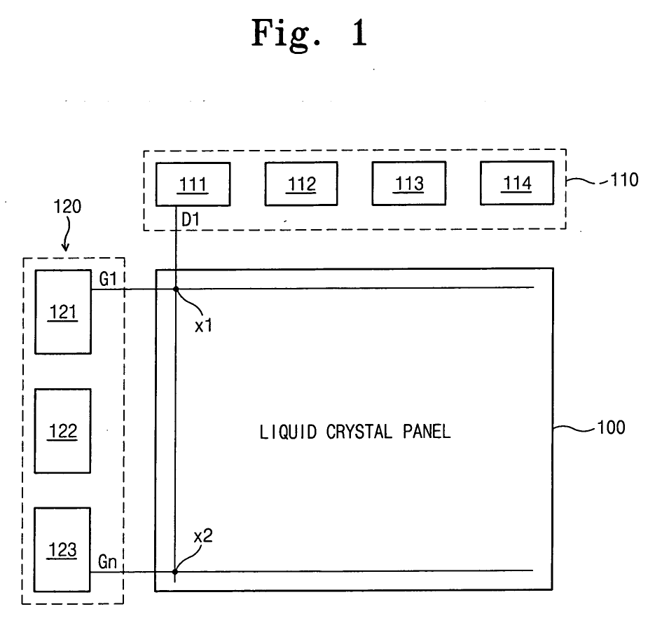

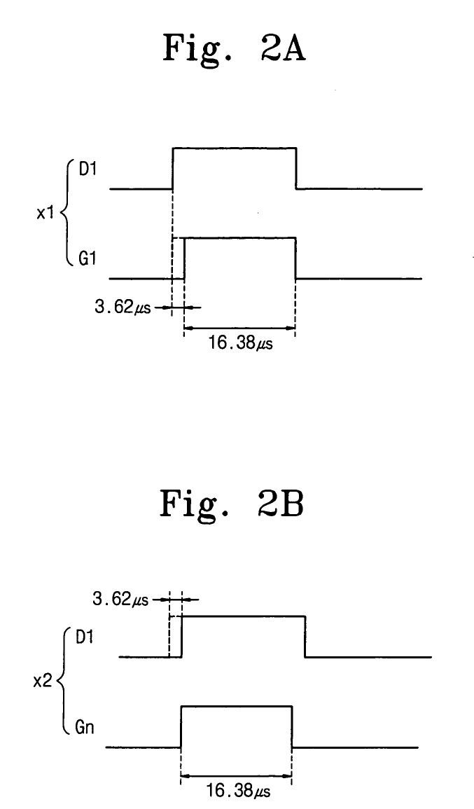

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

A flat panel display according to the present invention includes first and second clock signal lines whose line widths are adjusted such that a phase difference between a gate signal for driving a gate line at one end of a data line and another gate signal for driving another gate line at the other end of the data line corresponds to a signal delay time between the two ends of the data line. Accordingly, the flat panel display can prevent a malfunction that may be caused by the signal delay time.

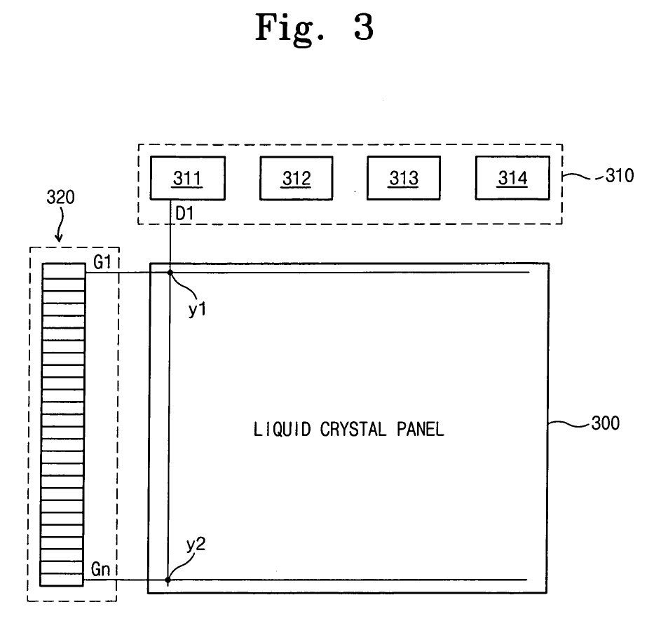

FIG. 3 is a block diagram of an LCD according to a preferred embodiment of the present invention.

Referring to FIG. 3, the LCD includes a liquid crystal panel 300, a source driver 310, and a gate drive circuit 320. The liquid crystal panel 300 includes a plurality of gate lines, a plurality of data lines perpendicularly intersecting the gate lines, and a plurality of pixels arranged at intersections of the gate lines and the data lines in a matrix form. The data lines are electrically insolated from the gate lines. Each of the pixels includes a TFT (not shown), a liquid crystal capacitor (not shown), and a storage capacitor (not shown). The TFT has a gate electrode connected to the gate line, a source electrode connected to the data line, and a drain electrode connected to the liquid crystal capacitor. The gate lines are sequentially selected by the gate drive circuit 320. When a gate-on voltage is applied to the selected gate lines in pulses, the TFTs connected to the gate lines are turned on. A voltage containing pixel information is applied to each of the data lines by the source driver 310. This voltage is applied to the liquid crystal capacitor and the storage capacitor through the TFT of the corresponding pixel. The liquid crystal capacitors and the storage capacitors are driven and an image display operation is achieved.

The source driver 310 includes a plurality of source driver ICs 311 to 314. In response to RGB data and control signals received from a timing controller (not shown), the source driver 310 generates signals for driving the source lines of the liquid crystal panel 300.

In response to control signals received from the timing controller, the gate drive circuit 320 sequentially scans the gate lines of the liquid crystal panel 300.

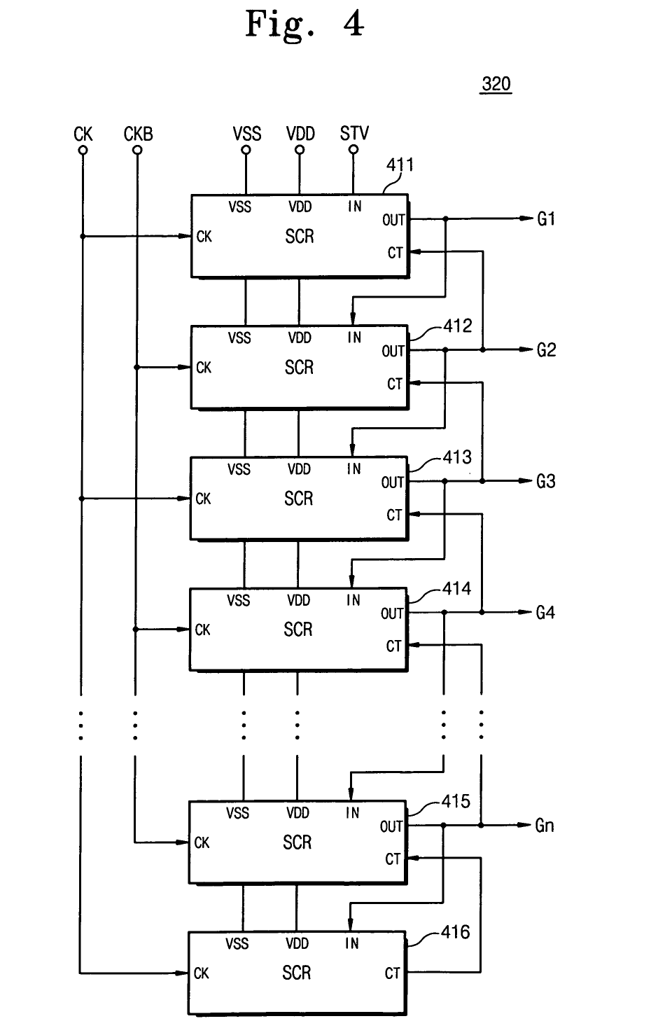

FIG. 4 is a detailed block diagram of the gate drive circuit 320.

Referring to FIG. 4, the gate drive circuit 320 includes n shift registers 411 to 415 and a dummy shift register 416. The LCD in FIG. 3 has a COG structure in which the shift registers 411 to 415, the dummy shift register 416, and the liquid crystal panel are formed on the same plane.

The shift registers 411 to 416 receive a source voltage VDD (a gate-on voltage), a ground voltage VSS (a gate-off voltage), a corresponding clock signal, and a corresponding control signal, and output gate signals G1 to Gn accordingly.

The first shift register 411 starts to operate in response to a scan start signal STV. The other shift registers 412 to 415 and the dummy shifter register 416 operate in response to the gate signals that are output signals from the preceding registers. Also, the gate signals from the shift registers 412 to 415 and the dummy shift register 416 are provided as control signals for the corresponding previous registers 411 to 415.

The odd-numbered shift registers 411 and 413 and the dummy shift register 416 receive a clock signal CK, and the even-numbered shift registers 412, 414 and 415 receive an inverted clock signal CKB.

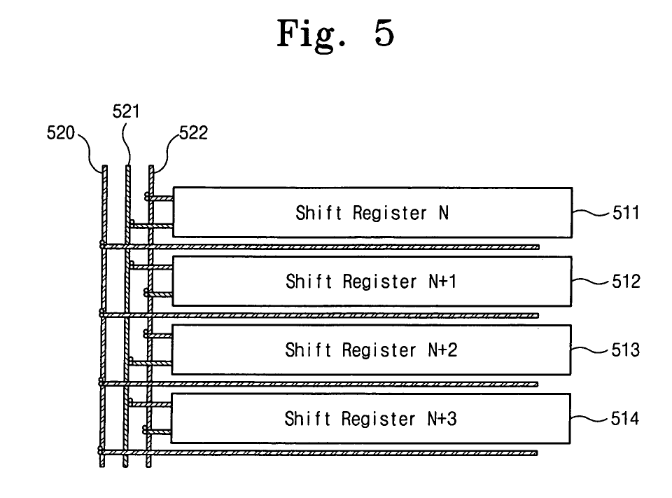

FIG. 5 is a diagram illustrating a partial line structure of the gate drive circuit 320.

Referring to FIG. 5, a ground voltage line 520, a first clock line 521 for providing the clock signal CK, and a second clock line 522 for providing the inverted clock signal CKB are arranged at the left side of shift registers 511 and 514.

The first and second clock lines 521 and 522 are designed to have a width according to the signal delay time in the data line D1 illustrated in FIG. 3. A delay time of a signal transmitted through a signal line is proportional to a time constant determined according to the resistance and capacitance of the signal line. Also, the resistance of the signal line is inversely proportional to the width of the signal line. Accordingly, the delay time of the signal transmitted though the signal line can be adjusted by the adjustment of the width of the signal line.

For example, a 12.1-inch WXGA LCD has the signal delay time of 3.62 μs when the data line D1 has a resistance of 37.77 KΩ and a capacitance of 83 pF. That is, referring to FIG. 3, the signal delay time between a start point y1 and an end point y2 of the data line D1 is 3.62 μs.

The line widths of the first and second clock lines 521 and 522 are adjusted to prevent a malfunction due to the signal delay time between the start point y1 and the end point y2.

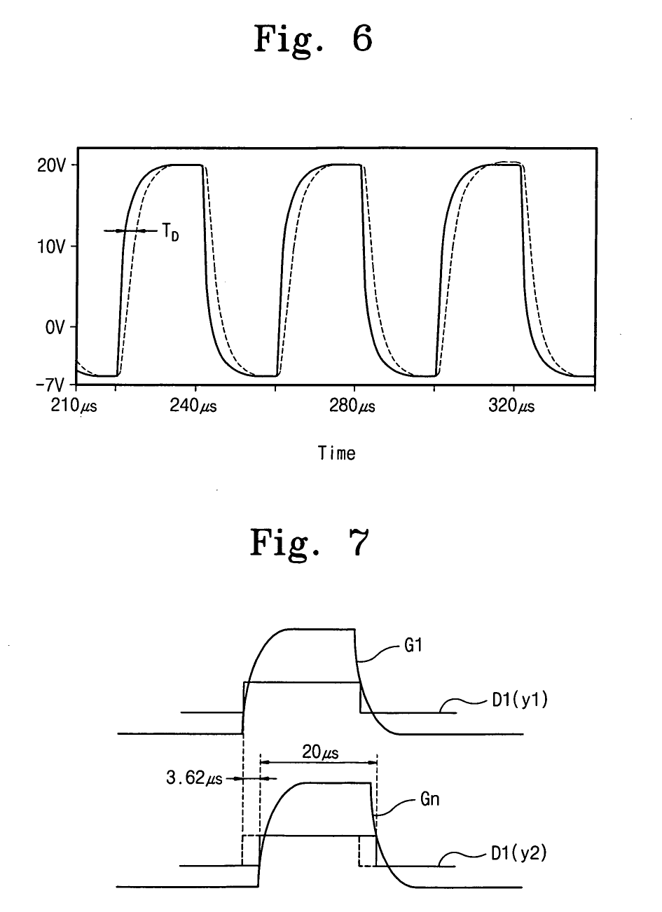

FIG. 6 illustrates a delay time T_{D} of the clock signal CK transmitted through the first clock line 521.

Referring to FIG. 6, a phase difference, which is a signal delay time T_{D}, exists between a clock signal CK at a point of the first clock line 521 corresponding to the start point y1 of the data line D1 and a clock signal CK at a point of the first clock line 521 corresponding to the end point y2 of the data line D1. When a signal delay time T_{D} of each of the clock signal CK and the inverted clock signal CKB is set to correspond to the signal delay time between the start and end points y1 and y2 of the data line D1, a phase difference occurs between the gate signals G1 and Gn. The delay time T_{D} of the clock signal CK and the inverted clock signal CKB can be set by the adjustment of the widths of the first and second clock lines 521 and 522, as described above.

FIG. 7 illustrates a delay time of the data signal D1 and a delay between the gate signals G1 and Gn.

Referring to FIG. 7, when the signal delay time of the data signal D1 between the start and end points y1 and y2 is 3.62 μs, the signal delay time between the gate signals G1 and Gn is 3.62 μs. The signal delay time between the gate signals G1 and Gn can be changed by the adjustment of the first and second clock lines 521 and 522 for transmitting the clock signal CK and the inverted clock signal CKB. At this time, the pulse widths of the gate signals G1 and Gn are maintained at 20 μs.

Conventionally, the pulse widths of the gate signals G1 and Gn are reduced by 3.62 μs (the delay time of the data signal D1) to prevent any malfunction due to the delay of the data signal D1. This change in the pulse widths, however, produces the undesirable side effect of reducing the pixel charging time, which also causes various display failures. In contrast to the conventional method, the present invention achieves the same prevention/reduction in the malfunction rate by adjusting the phase difference between the gate signals G1 and Gn. The line widths of the first and second clock lines 521 and 522 are adjusted without changing the pulse widths of the gate signals G1 and Gn, thereby preventing the malfunction due to the delay of the data signal D1.

As described above, the signal delay time between the two ends of the data line D1 is measured, the line widths of the clock lines 521 and 522 are set according to the measured signal delay time of the data line D1, and the gate lines G1 to Gn, the data line D1, and the clock signal lines 521 and 522 are integrated. Accordingly, it is possible to prevent any malfunction due to signal delay time between the two ends of the data signal line and to improve the image quality of the flat panel display.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A flat panel display comprising:
a plurality of gate lines;
at least one data line intersecting the gate lines, the data line being electrically isolated from the gate lines and having a predetermined signal delay time between one end and the other end of the data line;
a pixel array formed at intersections of the gate lines and the data line;
a first clock line for transmitting a first clock signal; and
a gate drive circuit for driving the gate lines in response to the first clock signal received through the first clock line,
wherein a width of the first clock line is determined according to the predetermined signal delay time of the data line.

2. The flat panel display of claim 1, further comprising a second clock line for transmitting a second clock signal,
wherein the gate drive circuit drives the gate lines in response to the first clock signal and the second clock signal.

3. The flat panel display of claim 2, wherein a width of the second clock line is determined according to the predetermined signal delay time of the data line.

4. The flat panel display of claim 2, wherein the second clock signal is an inverted signal with respect to the first clock signal.

5. The flat panel display of claim 2, wherein the gate drive circuit includes:
a first group of shift registers outputting a first group of gate signals for driving a first group of the gate lines in response to the first clock signal; and
a second group of shift registers outputting a second group of gate signals for driving a second group of the gate lines in response to the second clock signal.

6. The flat panel display of claim 1, wherein a phase difference between a gate signal for driving a first gate line at one end of the data line and another gate signal for driving a second gate line at the other end of the data line corresponds to the predetermined signal delay time.

7. The flat panel display of claim 1, wherein the flat panel display includes a liquid crystal display.

8. A method for manufacturing a flat panel display, comprising:
forming a plurality of gate lines;
forming at least one data line;
forming a first clock line having a first width that is determined according to a signal delay time of the data line.

9. The method of claim 8, further comprising forming a second clock line having a second width that is determined according to the signal delay time of the data line.

10. A method for manufacturing a flat panel display, comprising:
measuring a signal delay time between one end and the other end of a data line intersecting a plurality of gate lines, the data line being electrically isolated from the gate lines;
adjusting a width of a first clock line for transmitting a first clock signal to a gate drive circuit for driving the gate lines such that a phase difference between a first gate signal for driving a first gate line at one end of the data line and a second gate signal for driving a second gate line at the other end of the data line corresponds to the measured signal delay time of the data line; and
integrating the gate lines, the data line, and the first clock line.

11. The method of claim 10, further comprising setting a width of a second clock line according to the measured signal delay time of the data line, the second clock line transmitting a second clock signal to the gate drive circuit, the gate drive circuit driving the gate lines in response to the first clock signal and the second clock signal.
